(19) United States
(12) Patent Application Publication
(10) Pub. No.: US 2006/0040663 A1
(43) Pub. Date: Feb. 23, 2006

(54) Access point apparatus, radio communication system and connection method

(75) Inventors: Kotaro Ise, Saitama-Shi (JP); Masahiro Takagi, Toshima-ku (JP); Naohisa Shibuya, Kawasaki-shi (JP); Yoshihiko Kashio, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/194,617

(22) Filed: Aug. 2, 2005

(30) Foreign Application Priority Data
Aug. 17, 2004 (JP) 2004-237607

(51) Int. Cl. H04Q 7/20

(52) U.S. Cl. 455/434; 455/422.1

(57) ABSTRACT

An access point apparatus includes a first communication unit sending a radio terminal a beacon representing the availability of an access point apparatus, and receiving a connection request signal from the radio terminal in response to the beacon; a second communication unit communicating with a control unit which controls a load state of the access point apparatus via the first communication unit; a memory storing connection control information received from the control unit via the second communication unit, the connection control information depending upon the load state of the access point apparatus; and a connection control unit controlling the operation of the first communication unit on the basis of the connection control information.

### CROSS REFERENCE TO RELATED APPLICATION

This application is based upon and claims the benefit of priority from the prior Japanese Patent Application No. 2004-237,607 filed on Aug. 17, 2004, the entire contents of which is incorporated herein by reference.

### BACKGROUND OF THE INVENTION

1. Field of the Invention

This invention relates to an access point apparatus, a radio communication system constituted by radio equipment and a plurality of access point apparatuses, and a method of connecting the radio equipment via access point apparatuses.

2. Description of the Related Art

Up to now, the wireless communication standard called as IEEE 802.11a, 802.11b or 802.11g has been utilized for LANs (Local Area Networks) in business companies, universities and so on. Such a LAN is constituted by a plurality of radio equipment and a plurality of access points. The access points are connected by a cable network called as the ETHERNET (registered trade name) or the like.

Prior to communication, radio equipment connects to an access point apparatus, and transmits and receives communication data via the access point apparatus. With the foregoing communication standard, a terminal which has not established connection with an access point (called the “non-connected terminal”) cannot know loads on the access points such as the number of connected terminals, the number of transfer packets and so on. Therefore, such a non-connected terminal has a problem that it tends to be connected to an access point which has a heavy load compared with another connectable access point, and has to perform communications with an excessive delay or low throughput. This is a first problem of the related art.

Recently, proposals have been made in order to average loads between access points. For example, Japanese Patent Laid-Open Publication No. 2003-324,449 discloses “Radio Communication Terminal and Radio Relay System”. The publication is called the “Reference 1”. In the Reference 1, each respective access point apparatus notifies its load to a radio terminal, which connects to an access point apparatus having a lowest load. Although loads between the access point apparatuses are averaged, additional devices are necessary for the respective access point apparatuses to inform the radio terminal of their loads. This is because the radio communication standard, i.e., the IEEE 802.11a, 802.11b or 802.11g, has not specified such additional devices. This would lead to a second problem.

Japanese Patent Laid-Open Patent Application No. 2003-244,161 (Reference 2) discloses “Connection Device for Radio LAN System, Connecting Method, Radio LAN System Program, and Recording Medium for Radio LAN System”. In the Reference 2, access point apparatuses exchange load information one another, an access point apparatus having a light load transmits electromagnetic waves having low transmission power, and an access point apparatus having a heavy load transmits electromagnetic waves with high transmission power. However, when the transmission power is lowered while the load is heavy, a radio terminal repeatedly suffers from bit errors. This would lead to increased re-transmissions, a long delay, and a low throughput. This is a third problem of the related art. Further, when the access point apparatus with a heavy load lowers its transmission power, an adjacent access point apparatus with the low load raises the transmission power. However, if there are both heavy load access point apparatuses and light load access point apparatuses, the access point apparatuses having a high load is required to decrease the transmission power only in the direction of the access point apparatuses with the light load. For this purpose, it is conceivable to use a directional antenna. This would result in an increased cost, which is a fourth problem.

According to the foregoing radio communication standard, the radio equipment should establish a connection with one access point apparatus prior to communication. However, the radio terminal does not have a device which is used to know a load state of the access point apparatus. Therefore, access points may have disproportionate loads.

It is conceivable that access point apparatuses adopt a method of sending load information to radio equipment in order to overcome the fourth problem, which would lead to additional cost.

### BRIEF SUMMARY OF THE INVENTION

The present invention is aimed at providing an access point, a radio communication system and a radio communication connecting method in order to overcome problems of the related art.

In accordance with a first aspect of the embodiment of the invention, there is provided an access point apparatus includes: a first communication unit sending a radio terminal a beacon representing the availability of an access point apparatus, and receiving a connection request signal from the radio terminal in response to the beacon; a second communication unit communicating with a control unit which controls a load state of the access point apparatus via the first communication unit; a memory storing connection control information received from the control unit via the second communication unit, the connection control information depending upon the load state of the access point apparatus; and a connection control unit controlling the operation of the first communication unit on the basis of the connection control information.

According to a second aspect of the embodiment of the invention, there is provided an access point apparatus includes a first communication unit receiving via a radio terminal a search request signal representing the availability of an access point apparatus, and sending a search response signal via the radio terminal in response to the search request signal; a second communication unit connected to a control unit which controls a load state of an access point apparatus via the first communication unit; a memory storing connection control information received from the control unit via the second communication unit, the connection control information depending upon the load state of the access point apparatus; and a connection control unit controlling the operation of the first communication unit on the basis of the connection control information.

In accordance with a third aspect of the embodiment of the invention, there is provided a radio communication system includes a plurality of radio terminals; a plurality of access point apparatuses connected to the radio terminals; and a control unit controlling load states of the access point apparatuses. Each access point apparatus comprises a first communication unit sending a radio terminal a beacon representing the availability of the access point device and receiving a connection request signal from the radio terminal in response to the beacon; a second communication unit connected to the control unit and receiving connection control information from the control unit, the connection control information depending upon the load state; and a connection control unit controlling the operation of the first communication unit on the basis of the connection control information.

According to a fifth aspect of the embodiment of the invention, there is provided a radio communication system includes a plurality of radio terminals; a plurality of access point apparatus connected to the radio terminals; and a control unit controlling load states of the access point apparatuses. Each access point apparatus comprises a first communication unit receiving a search request signal representing the availability of an access point apparatus from the radio terminal and sending a search response signal in response to the search request signal; a second communication unit connected to the control unit and receiving connection control information from the control unit, the connection control information depending upon the load state; and a connection control unit controlling the operation of the first communication unit on the basis of the connection control information.

### BRIEF DESCRIPTION OF THE SEVERAL VIEWS OF THE DRAWINGS

FIG. 1 shows an overall configuration of a radio communication system 100 according to a first embodiment of the invention;

FIG. 2 is a block diagram showing details of the radio communication system 100;

FIG. 3 is a flowchart showing the operation of the radio communication system 100;

FIG. 4 shows a modified example of the radio communication system of FIG. 1;

FIG. 5 is a block diagram showing a radio communication system 300 according to a second embodiment;

FIG. 6 is a flowchart showing the operation of the radio communication system 300;

FIG. 7 is a block diagram showing a radio communication system 400 according to a third embodiment;

FIG. 8 is a flowchart showing the operation of the radio communication system 400.

FIG. 9 is a block diagram showing a radio communication system 500 according to a fourth embodiment;

FIG. 10 is a flowchart showing the operation of the radio communication system 500;

FIG. 11 is a block diagram showing a radio communication system 600 according to a fifth embodiment;

FIG. 12 is a flowchart showing the operation of the radio communication system 600;

FIG. 13 shows an overall configuration of a modified example of any one of the first to fifth embodiments; and

FIG. 14 shows an overall configuration of a further modified example of any one of the first to fifth embodiments.

### DETAILED DESCRIPTION OF THE INVENTION

Various embodiments of the present invention will be described with reference to the drawings. It is to be noted that the same or similar reference numerals are applied to the same or similar parts and elements throughout the drawings, and the description of the same or similar parts and elements will be omitted or simplified.

In a network constituted by access point apparatuses and radio equipment, the present invention aims at averaging loads in the access point apparatuses in order to assure short delay and high throughput communications. Each access point apparatus notifies its own load state to the radio equipment using beacon frames or controlling probe responses.

### First Embodiment

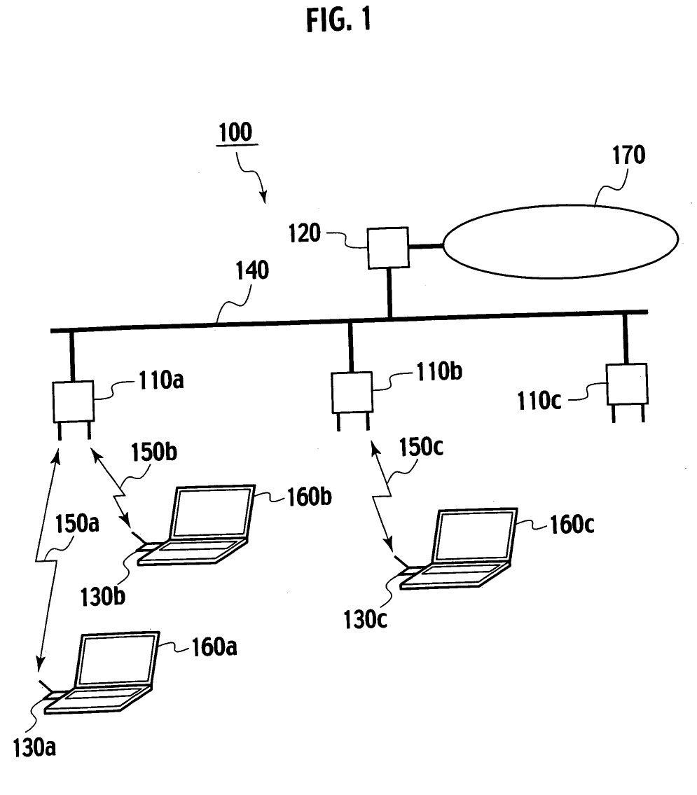

Referring to FIG. 1, a radio communication system 100 comprises access point apparatuses 110 (i.e., 110a, 110b and 110c); a control unit 120 connected to the access point apparatuses 110 via an internal network 140 and to an external network 170; radio equipment 130 (i.e., 130a, 130b and 130c) connected to the access point apparatuses 110 via radio channels 150; and terminals 160 (160a, 160b and 160c) connected to the radio equipment 130.

Each access point apparatus 110 communicates with one or more radio equipment 130 via one of the radio channels 150. In short, the access point apparatus 110 is accessible to a predetermined number of radio equipment 130, and connects the radio equipment 130 to the internal network 140. When a plurality of the access points apparatuses 110 are provided as shown in FIG. 1, they are positioned with predetermined spaces kept therebetween, and are connected one another via the internal network 140. Each access point apparatus 110 operates in accordance with the radio communication standard IEEE 802.11a, 802.11b or 11g. In the first embodiment, the access point apparatus 110 can notify the control unit 120 of load state information. The load state information represents parameters such as the number of connected radio equipment 130, the number of packets per second or bytes per second which the radio equipment 130 transmits and receives, load of hardware constituting the access point apparatus 110, and a bit error rate of radio channels. These parameters may be used in combination.

The control unit 120 controls load states of a plurality of access point apparatuses 110a to 110c, and is a server computer, for example. The control unit 120 separately stores load information from each access point apparatus 110, and controls new connections between the access point apparatus 110 and radio equipment 130.

Each radio equipment 130 is a radio terminal, which is connected to each access point apparatus 110 as a key station via each radio channel 150, and is directly connected to each terminal device 160. Further, the radio equipment 130 connects the terminal device 160 to the internal network 140 via the access point apparatus 110.

The internal network 140 connects the access point apparatuses 110a to 110c, and serves as a local area network (LAN) which connects the terminal devices 160a to 160c with one another. The internal network 140 is set up using the ETHERNET based on the TCP/IP protocol, for example. In the example shown in FIG. 1, the internal network 140 is constituted by a cable. Alternatively, the internal network 140 may be on the wireless basis.

Each terminal device 160 is connected to the internal network 140 via the radio equipment 130, and is a personal computer, for example. In FIG. 1, the radio equipment 130 is integral with the terminal device 160. Alternatively, they are connected using a serial cable or a USB cable.

The external network 170 is an internet or a wide area network WAN, for example, and connects the terminal device 160 to another terminal device 160 at a remote location or the like via the radio channels 150 and the internal network 140.

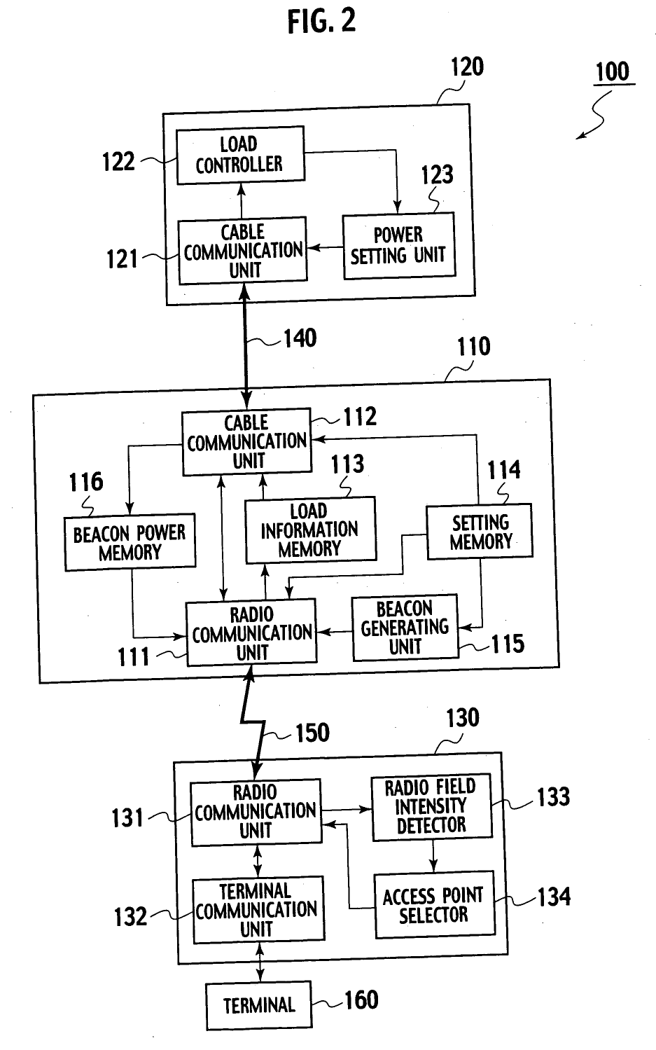

The radio communication system 100 will be described in detail with reference to FIG. 2, in which the external network 170 is omitted.

Each of the access point apparatus 110 comprises a radio communication unit 111; a cable communication unit 112; a load information memory 113; a setting memory 114; a beacon generating unit 115; and a beacon power memory 116.

The radio communication unit 111 includes a radio interface which satisfies the radio communication standard IEEE 802.11a, 802.11b or 802.11g. The radio communication unit 111 not only receives a data packet from the cable communication unit 112 and a beacon frame generated by the beacon generating unit 115, but also sends them to the radio equipment 130 via the radio channel 150. The radio communication unit 111 transfers the data packet received from the radio equipment 130 via the radio channel 150 to the cable communication unit 112 via the radio channel 150.

The cable communication unit 112 communicates with access point apparatuses 110 and the control unit 120 via the internal network 140, or with a terminal device connected to the external network 170, and includes a cable communication interface such as the ETHERNET, for example. Further, the cable communication unit 112 periodically provides the control unit 120 with connection information, e.g., the load information, stored in the load information memory 113. Alternatively, the foregoing parameters may be transmitted to the control unit 120. The cable communication unit 112 refers to an address of the control unit 120 in the internal network 140. The address is stored in the setting memory 114.

The load information memory 113 stores information of the radio equipment 130 connected thereto. When the access point apparatus 110 is connected to the radio equipment 130, the load information memory 113 stores an identification code of the radio equipment 130 such as a MAC address, as connection information. Conversely, when the connection is interrupted, the load information memory 113 deletes the connection information.

The setting memory 114 stores parameters which determine the operation of the access point apparatuses 110, i.e., the address of the control unit 120 in the internal network 140, transmission power of data packets, transmission power of the beacon frame, transmission timings, a service set identifier (SSID), and radio channel number.

The beacon generating unit 115 generates beacon frames, and controls transmission of them. The beacon frames are periodically transmitted to the radio equipment 130 via the radio channel 150. In other words, the beacon generating unit 115 generates beacon frames on the basis of parameters stored in the setting memory 114, such as the service set identifier and radio channel number information, and transfers the beacon frame to the radio communication unit 111.

A beacon power memory 116 stores beacon transmission power information which is used to send beacon frames and is received from the control unit 120. If no new beacon transmission power information arrives from the control unit 120 within a specified time period, the beacon transmission power memory 116 deletes the stored beacon power information.

Referring to FIG. 2, the control unit 120 constituting the radio communication system 100 comprises a cable communication unit 121, a load controller 122, and a power setting unit 123.

The cable communication unit 121 is equivalent to the cable communication unit 112 of the access point apparatuses 110, and includes a cable communication interface communicating with the access point apparatus 110 via the internal network 140. The cable communication interface is an ETHERNET, for example.

The load controller 122 receives the load information from the access point apparatus 110, controls the load state of the access point apparatus 110. Further, the load control unit 122 controls new connections between the radio equipment 130 and the access point apparatus 110 in response to the load on the access point apparatus 110.

The power setting unit 123 requests the cable communication unit 121 to send the beacon power information as instructed by the load controller 122. Hence, the power setting unit 123 controls transmission power of the beacon frames to be transmitted from the access point apparatuses 110 in response to instructions from the load controller 122.

The radio equipment 130 comprises a radio communication unit 131, a terminal communication unit 132, a radio signal intensity detector 133, and an access point selector 134. Refer to FIG. 2.

The radio communication unit 131 is equivalent to the radio communication unit 111 of the access point apparatus 110, and includes a radio interface for connection to the access point apparatus 110 via the radio channel 150. The radio communication unit 111 receives a data packet or a beacon frame from the access point apparatus 110, transfers it to the terminal communication unit 132 and the radio signal intensity detector 133, and returns the data packet from the terminal communication unit 132 to the access point apparatus 110.

The terminal communication unit 132 is an interface connecting the radio equipment 130 to the terminal device 160, and is a serial interface, a PCMCIA interface, or a USB interface, for example. The terminal communication unit 132 transfers the data packet from the radio terminal unit 131 to the terminal device 160, and transfers the data packet from the terminal device 160 to the radio communication unit 131.

The radio signal intensity detector 133 detects a radio signal intensity of the beacon frame which is received by the radio communication unit 131 from the access point apparatus 110. When there are a plurality of access point apparatuses 110, the radio signal intensity detector 133 detects signal intensities of respective access point apparatuses 110, and transfers them to the access point apparatus selector 134.

The access point apparatus selector 134 selects an access point apparatus 110 to be connected, in accordance with the radio signal intensity detected by the signal intensity detector 133.

The radio communication system 100 includes the beacon power memory, and increases or decreases beacon transmitting power in accordance with the load state in the access point apparatus 110.

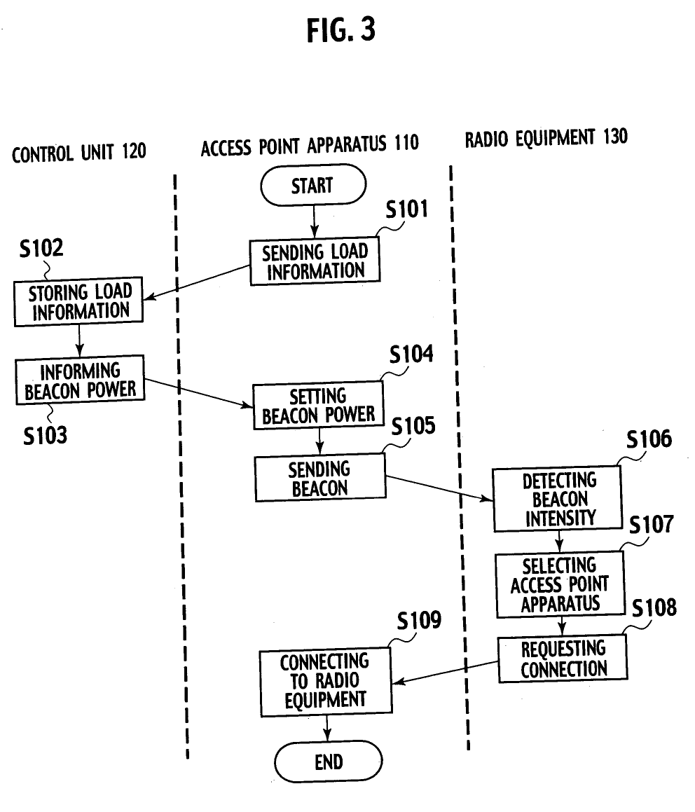

The operation of the radio communication system 100 will be described hereinafter with reference to FIG. 2 and FIG. 3. FIG. 3 shows the operations of the access point apparatus 110, control unit 120 and radio equipment 130 in parallel.

In the radio communication system 100, the load information memory 113 has stored the connection information of the radio equipments 130 currently in connection. The cable communication unit 112 reads the connection information from the load information memory 113, and periodically sends the connection information as the load information of the access point apparatus 110 to the control unit 120 via the internal network 140 in step S101. The access point apparatus 110 may periodically send the load information to the control unit 120, or whenever the load state changes.

Receiving the load information via the internal network 140, the cable communication unit 121 of the control unit 120 transfer the load information to the load controller 122, which stores the load information in an internal memory (step S102).

When the load information is stored, the load controller 122 creates new connection control information for respective access point apparatuses 110 in accordance with their load states, and sends the connection control information to a power setting unit 123. The power setting unit 123 determines beacon transmitting power for the respective access point apparatuses 110 in accordance with the connection control information. The cable communication unit 121 periodically sends the beacon power information to the access point apparatuses 110 via the internal network 140 (step S103).

The beacon power information includes beacon frame transmission power to be sent by the access point apparatus 110, and is created for each access point apparatus 110 under control of the control unit 120. The beacon frame transmission power is determined on the basis of the load information of respective access point apparatuses 110. In short, low transmission power is set for an access point apparatus having a heavy load while high transmission power is set to an access point apparatus having a light load. The foregoing transmission power is derived using the following formula.
Transmission power(AP_{—}i)=Pmin+(Pmax−Pmin)×(Max. load−Load(AP_{—}i))/(Max. load−Min.load) [Formula 1]
where the “transmission power (AP_i)” denotes transmission power included in the beacon power information which is sent to an access point apparatus AP_i; the “Max. load” denotes a maximum load among access point apparatuses; the “Min. load” denotes a minimum load among access point apparatuses; “Load (AP_i)” denotes a load of the access point apparatus AP_i; “Pmax” denotes predetermined maximum transmission power; and “Pmin” denotes predetermined minimum transmission power.

The cable communication unit 112 of the access point apparatus 110 receives beacon power information destined thereto via the internal network 140, and stores the information in the beacon power memory 116 (step S104).

The beacon generating unit 115 generates beacon frames at timings which have been stored in the setting memory 114, and demands the radio communication unit 111 to send the beacon frames. In accordance with the received beacon power information, the radio communication unit 111 sends the beacon frames at transmission power determined by the power setting unit 123 of the control unit 120 (step S105). The beacon power information is referred to only when the beacon frames are transmitted. The transmission power stored beforehand in the setting memory 114 is referred to when the data packets are transmitted. In other words, the radio communication unit 111 increases or decreases the transmission power only when sending the beacon frames. Further, the radio communication unit 111 transmits the beacon frames with reference to the transmission power stored in the setting memory 114 when the beacon power memory 116 does not possess the beacon power information.

The radio communication unit 131 of the radio equipment 130 receives the beacon frame via the radio channel 150, and informs the radio signal intensity detector 133 of a radio signal intensity of the beacon frame (step S106). Alternatively, the radio equipment 130 may receive a plurality of beacon frames having different radio frequencies, and the radio signal intensity detector 133 may obtain radio signal intensities of beacon frames having different radio frequencies.

When the signal intensities of the beacon frames are received, the access point selector 134 selects an access point apparatus 110 in accordance with the signal intensity (step S107). Specifically, the access point selector 134 compares the signal intensities of the beacon frames, and selects the access point apparatus 110 which has sent the beacon frame having the maximum radio signal intensity. Access point apparatuses 110 having heavy loads send beacon frames with low transmission power while access point apparatuses 110 having light loads send beacon frames with high transmission power. Therefore, either the access point apparatus with a light load or the access point apparatus nearest the radio communication unit 130 is selected as the access point apparatus 110 having the beacon frame with the maximum signal intensity.

When the access point apparatus 110 having the maximum radio signal intensity is selected, the radio communication unit 131 sends a connection request (for example, an Association Request message) to the selected access point apparatus 110 (step S108).

In response to the connection request, the access point apparatus 110 gets access to the radio communication unit 130, and stores an identification code of the radio communication unit 130 in the load information memory 113 (step S109).

With the radio communication system of this embodiment, the access point apparatus sends the beacon frame in accordance with the load thereof. The radio communication unit provides the connection request to the access point apparatus having the maximum radio signal intensity of the beacon frame, and connects to the access point apparatus whose load is light. This is effective in averaging the loads between the access point apparatuses.

Further, the access point apparatuses control beacon transmission power in accordance with their own loads, and transmit data packets at normal transmission power. It is possible to notify the radio equipment of the loads of the access point apparatuses without worsening the bit error rate.

The beacon frames are generated by the beacon generating unit 115 of the access point apparatus 110. Alternatively, the beacon frames may be generated by an external unit of the access point apparatus 110, e.g., the control unit 120, and are sent to the access point apparatus 110 via the internal network 140. The access point apparatus 110 may send the beacon frame received from the cable communication unit 112 via the radio communication unit 111.

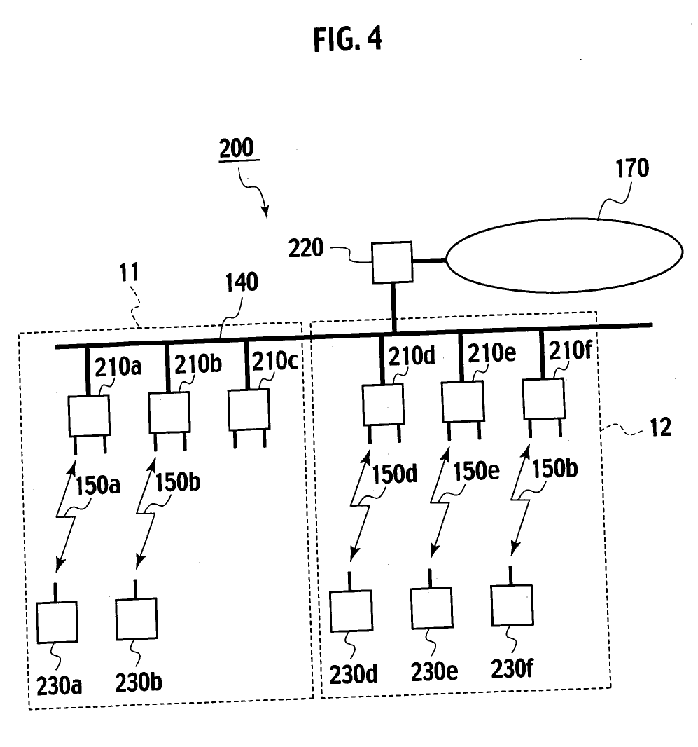

A modified radio communication system 200 is shown in FIG. 4. With the radio communication system of FIG. 1, the control unit 120 controls the load information of all of the access point apparatuses 110 under control, and decides beacon power for all of the access point apparatuses 110. However, depending upon the number of access point apparatuses 110 to be controlled or positional relationships of the access point apparatuses 110, it is sometimes impossible to decide appropriate beacon power. In the modified example, the access point apparatuses are divided into a plurality of groups, and beacon power is decided for each group.

Referring to FIG. 4, the radio communication system 200 comprises a plurality of access point apparatuses 210, a control unit 220 connected to the access point apparatuses 210 via an internal network 140, and a plurality of radio communication units 230 connected to the access point apparatuses 210 via radio channels 150. Compared with the radio communication system 100 of FIG. 1, the radio communication system 200 is divided into a group 11 which includes the access point apparatuses 210a to 210c and a group 12 which includes the access point apparatuses 210d to 210f.

The control unit 220 controls load information of the access point apparatus 210a to 210c in the group 11, generates beacon power information for the access point apparatuses 210a to 210c, and sends the beacon power information to the access point apparatuses 210a to 210c. Similarly, the control unit 220 controls load information of the access point apparatus 210d to 210f in the group 12, generates beacon power information for the access point apparatuses 210d to 210f, and sends the beacon power information to the access point apparatuses 210d to 210f. The group 11 and the group 12 are identified and managed on the basis of addresses such as IP addresses in the internal network 140 of the access point apparatuses 210a to 210f. Alternatively, group identifiers may be stored in the setting memory 114, so that the groups 11 and 12 may be identified using the group identifiers. The beacon frame transmission power for each group is calculated using the following formula.
Transmission power(AP_{—}gi)=Pmin+(Pmax−Pmin)×(Max. load g−Load(AP_{—}gi))/(Max. load g−Min.load g) [Formula 2]
where the “transmission power (AP_gi)” denotes transmission power included in the beacon power information which is sent to an access point apparatus AP_gi in group g; the “Max. load g” denotes maximum load of an access point apparatuses in group g; the “Min. load g” denotes minimum load of an access point apparatuses in group g; “Load (AP_gi)” denotes a load of the access point apparatus AP_gi in group g; “Pmax” denotes predetermined maximum transmission power; and “Pmin” denotes predetermined minimum transmission power.

The control unit 220 calculates the beacon transmission power as described above, which is effective in averaging the loads in the respective groups.

The beacon frames are generated by the beacon generating unit 115 of the access point apparatus 210. Alternatively, the beacon frames may be generated by an external unit of the access point apparatus 210, e.g., the control unit 220, and are sent the access point apparatus 210 via the internal network 140. The access point apparatus 210 may send the beacon frame received from the cable communication unit 112 via the radio communication unit 111.

### Second Embodiment

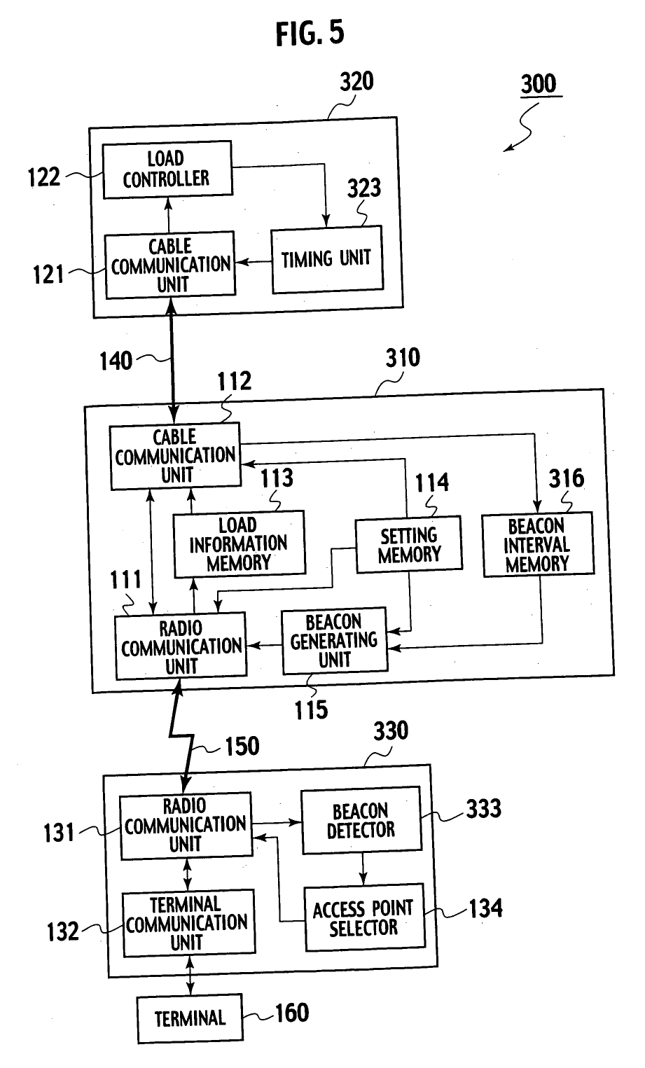

A second embodiment of the invention will be described with reference to FIG. 5. In the radio communication system 100 of the first embodiment, the transmission power of the beacon frames to be sent by the access point apparatuses is controlled in accordance with the load states of the access point apparatuses. This enables the radio communication unit 130 to connect to an access point apparatus 110 having a light load. In the second embodiment, a radio communication system 300 controls transmission intervals of the beacon frames in place of the transmission power of the beacon frames.

Referring to FIG. 5, the radio communication system 300 comprises access point apparatuses 310, a control unit 320 connected to the access point apparatuses 310 via an internal network 140, and a radio communication unit 330 connected to a terminal device 160 and to the access point apparatuses 310 via a radio channel 150.

The access point apparatuses 310 include a beacon interval memory 316 in place of the beacon power memory 116 of the access point apparatus 110. The beacon interval memory 316 stores beacon frame transmitting interval information (called the “beacon interval information”) received from the control unit 320, and stores the information. If no new beacon interval information arrives from the control unit 320 within predetermined time, the beacon interval memory 316 deletes the existing beacon interval information.

The control unit 320 includes a timing unit 323 in place of the power setting unit 123 in the first embodiment. The timing unit 323 controls the intervals of the beacon frames to be sent by the access point apparatuses 310, and sends the beacon interval information to the cable communication unit 121 in response to a demand from the load controller 122.

The radio equipment 330 includes a beacon detector 333 in place of the radio signal intensity detector 133 in the first embodiment. The beacon detector 333 extracts a beacon frame from the data received by the radio communication unit 131 from the access point apparatus 310, identifies the access point apparatus 310 which has sent the beacon frame, and instructs the access point apparatus selector 134 to connect to the access point apparatus 310.

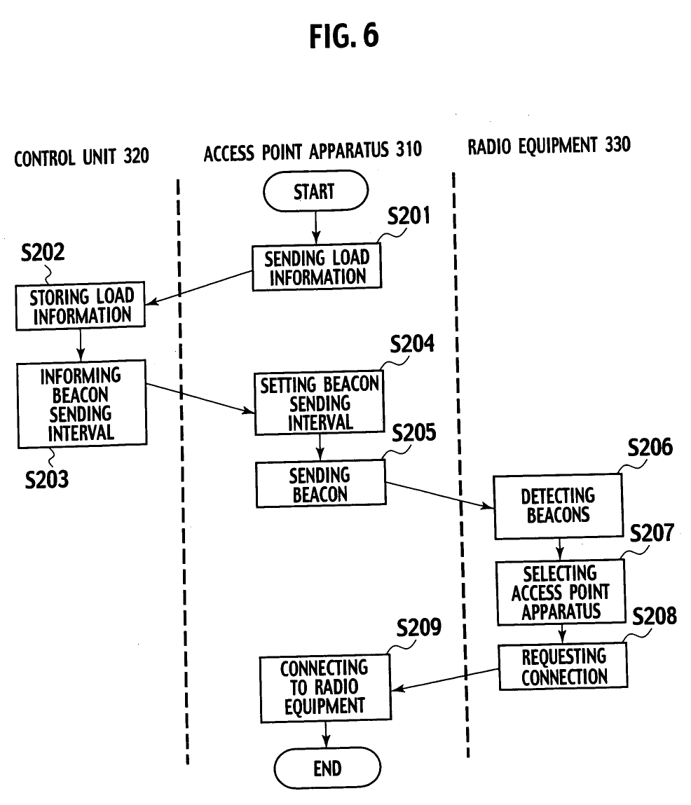

The operation of the radio communication system 300 will be described with reference to FIG. 6 showing in parallel the operation sequences of the control unit 320, radio equipment 330 and access point apparatus 310.

The load information memory 113 of the access point apparatus 310 has stored the connection information representing the radio communication unit 330 in connection. The cable communication unit 112 reads the connection information as load information of the access point apparatus 310 from the load information memory 113, and periodically sends via the internal network 140 (step S201). Alternatively, the access point apparatus 310 may periodically send the load information, or may send the load information whenever its load state changes.

Upon receiving the load information via the internal network 140, the cable communication unit 121 of the control unit 320 transfers the load information to the load controller 122, which stores the load information in an internal memory (step S202).

The load controller 122 creates new connection control information for the respective access point apparatuses 310 in accordance with their load states, and sends the new connection control information to a timing unit 323. The timing unit 323 decides beacon time intervals for the respective access point apparatuses 310, and creates beacon interval information. The radio communication unit 121 periodically sends the created beacon time interval information to the respective access point apparatuses 310 via the internal network 140 (step S203).

The beacon interval information also covers beacon frame transmission interval information, which is created for the respective access point apparatuses 310 under control of the control unit 320. The beacon frame transmission intervals are determined on the basis of the load information of the access point apparatuses 310. In other words, longer intervals are set for access point apparatus having heavy loads while shorter intervals are set for access point apparatuses 310 having light loads. The beacon frame transmission intervals are calculated using the following formula.
Transmission interval(AP_{—}i)=Tmin+(Tmax−Tmin)×(Max. load−Load(AP_{—}i))/(Max. load−Min. load) [Formula 3]
where the “Transmission interval (AP_gi)” denotes beacon frame transmission intervals at which an access point apparatus AP_i sends beacon frames; the “Max. load” denotes maximum load of access point apparatuses; the “Min. load” denotes minimum load of access point apparatuses; “Load (AP_i)” denotes load of the access point apparatus AP_i; “Tmax” denotes a predetermined maximum transmission interval; and “Pmin” denotes a predetermined minimum transmission interval.

The cable communication unit 112 of the access point apparatus 310 receives beacon timing information destined to itself via the internal network 140, and stores the received information in the beacon interval memory 316 (step S204).

The beacon generating unit 115 generates beacon frames in accordance with the beacon frame transmission intervals in the beacon time interval information stored in the beacon time interval memory 316, and orders the radio communication unit 111 to send the beacon frames. Thereafter, the radio communication unit 111 sends the beacon frames at the predetermined transmission power stored in the setting memory 114 (step S205). If there is no beacon interval information in the beacon time interval memory 316, the beacon generating unit 115 generates beacon frames at the transmission intervals stored in the setting memory 114, and sends the beacon frames to the radio communication unit 131 via the radio communication unit 111.

The radio communication unit 131 of the radio equipment 330 receives the beacon frames via the radio channel 150. Then, the beacon detector 333 identifies the access point apparatus 310 which corresponds to the first beacon frame received by the radio communication unit 131 (step S206).

Once the access point apparatus 310 which has sent the beacon frame is pinpointed, the access point apparatus selector 134 selects the access point apparatus 310 a (step S207).

The radio communication unit 131 sends a connection request (for example an Association Request message) to the selected access point apparatus 310 (step 208).

Receiving the connection request, the access point apparatus 310 connects to the radio equipment 330 which has issued the connection request (step S209).

According to this embodiment, the access point apparatus sends beacon frames at intervals depending upon its own load, which enables the radio equipment to receive beacon frames from access point apparatuses having light loads. Therefore, the radio equipment can issue the connection request to such access point apparatus, which is effective in averaging loads between access point apparatuses.

Further, since the transmission power of the access point apparatuses is not changed, it is possible to inform the radio equipment of the load of the access point apparatus without worsening the bit error rate.

Still further, the radio equipment 330 is required only to issue the connection request to the access point apparatus 130 whose beacon frame has been received first. No special and additional unit will be required.

With the foregoing radio communication system, the radio equipment issues the connection request to the access point apparatus from which the beacon frame is received first. Alternatively, the beacon detector 333 may compare the intervals of the beacon frames from the respective access point apparatuses, and select the access point apparatus 310 whose beacon frames have short intervals. This is effective in reliably selecting access point apparatus having light loads.

Further, the beacon frame generating unit 115 generates the beacon frames. Alternatively, the beacon frames may be generated by a unit external to the access point apparatus 310, e.g., the control unit 320, be sent to the access point apparatus 310 via the internal network 140. The access point apparatus 310 may transfer the beacon frames, received from the radio communication unit 112, via the radio communication unit 111.

With the radio communication system shown in FIG. 5, the control unit 320 controls the load information of the access point apparatuses 310 under its control, and determines the beacon transmission intervals. Alternatively, the access point apparatus may be divided into a plurality of groups, and beacon transmission intervals may be determined for each group.

As with the modified example of the first embodiment (shown in FIG. 4), the control unit 320 controls the load information of a plurality of access point apparatuses 310 in the first group, creates beacon interval information for the respective access point apparatuses 310, and sends the information to the access point apparatuses 310 in the first group. Further, the control unit 320 controls the load information of a plurality of access point apparatuses 310 in the second group, creates beacon interval information for the respective access point apparatuses 310, and sends the information to the access point apparatuses 310. In short, the control unit 320 separately controls the access point apparatuses 310 in the first and second groups. In this case, the first and second groups may be identified and managed on the basis of addresses such as IP addresses of the access point apparatuses 310 in the internal network 140. Alternatively, group identifiers may be stored in the setting memory 114 in order to identify the first and second groups. The beacon frame transmission intervals will be calculated using the following formula, for example.
Transmission interval(AP_{—}gi)=Tmin+(Tmax−Tmin)×(Max. load g−load(AP_{—}gi))/(Max. load g−Min. load g) [Formula 4]
where the “Transmission time interval (AP_gi)” denotes beacon frame sending intervals at which a group-g access point apparatus AP_i sends beacon frames; the “Max. load g” denotes a maximum load of the group-g access point apparatuses; the “Min. load g” denotes a minimum load of the group-g access point apparatuses; “Load (AP_i)” denotes load of the group-g access point apparatus AP_i; “Tmax” denotes a predetermined maximum transmission interval; and “Tmin” denotes a predetermined minimum transmission interval.

The foregoing calculation of the beacon transmission interval is effective in averaging load of the access point apparatuses in each group.

Further, the beacon generating unit 115 generates the beacon frames. Alternatively, the beacon frames may be generated by a unit external to the access point apparatus 310, e.g., the control unit 320, be sent to the access point apparatus 310 via the internal network 140. The access point apparatus 310 may transfer the beacon frames, received from the cable communication unit 112, via the radio communication unit 111.

### Third Embodiment

A radio communication system 400 in a third embodiment will be described hereinafter. With the radio communication systems 100, 200 and 300 in the first and second embodiments, the radio equipment receives beacon frames, and selects an access point apparatus to be connected. A so-called “passive search” is conducted. In the third embodiment, the radio communication system 400 conducts an “active search”, in which radio equipment sends a search signal (called “probe request”), and an access point apparatus to be connected is selected from access point apparatuses responding to the search signal.

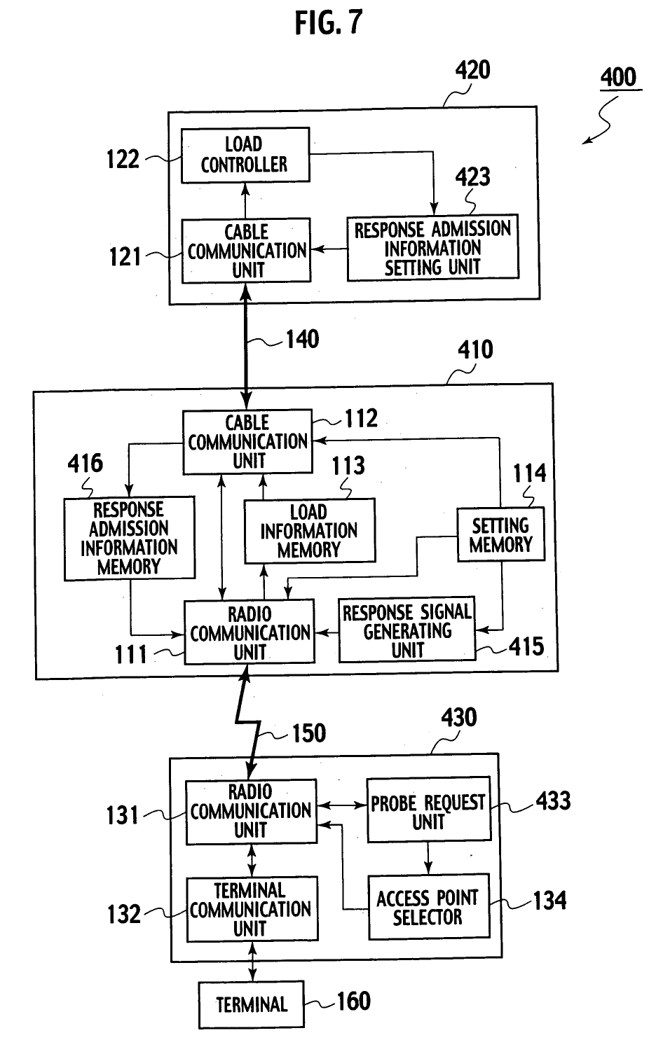

Referring to FIG. 7, the radio communication system 400 comprises access point apparatuses 410, a control unit 420 connected to the access point apparatuses 410 via an internal network 140, and radio equipment 430 connected to the access point apparatuses 410 via a radio channel 150.

The access point apparatus 410 includes a response signal generator 415 and a response admission information memory 416 in place of the beacon generating unit 115 and the beacon power memory 116 which are included in the access point apparatus 110 of the first embodiment.

The response signal generator 415 generates a probe response signal in response to a probe request from the radio equipment 430. The probe response signal represents that a connection can be established in response to the probe request from the radio equipment 430. The response signal generator 415 reads parameters such as a service set identifier and radio channel number from the setting memory 114, creates the probe response signal, and asks the radio communication unit 111 to transmit the probe response signal.

The response admission information memory 416 stores the probe response admission information received from the control unit 420. The probe response admission information includes probe response control signal representing the transmission or non-transmission of the probe response signal from the access point apparatus 410. Further, the response admission information memory 416 deletes the existing probe admission information when no further new probe admission information arrives from the control unit 420 for a predetermine time period.

Referring to FIG. 7, the control unit 420 includes a response admission information setting unit 423 in place of the power setting unit 123 in the control unit 120 of the first embodiment. The response admission information setting unit 423 controls the transmission or non-transmission of the probe response signal to be sent by the access point apparatus 410 in response to the command from the load controller 122. Further, the response admission information setting unit 423 generates the probe response admission information, and asks the cable communication unit 121 to send the probe response admission information.

The radio equipment 430 shown in FIG. 7 includes a probe request unit 433 in place of the radio signal intensity detector 133 used in the control unit 130 of the first embodiment. In response to a connection request from a user via the terminal 160, the probe request unit 433 issues a probe request signal, and searches an access point apparatus 410 which responds to the probe request signal. Specifically, prior to establishing a connection between the radio equipment 430 and an access point apparatus 410, the probe request unit 433 issues the probe request signal, and demands the radio communication unit 131 to send the probe request signal. Further, the probe request unit 433 pinpoints an access point apparatus 410 to be connected when a probe response signal is received.

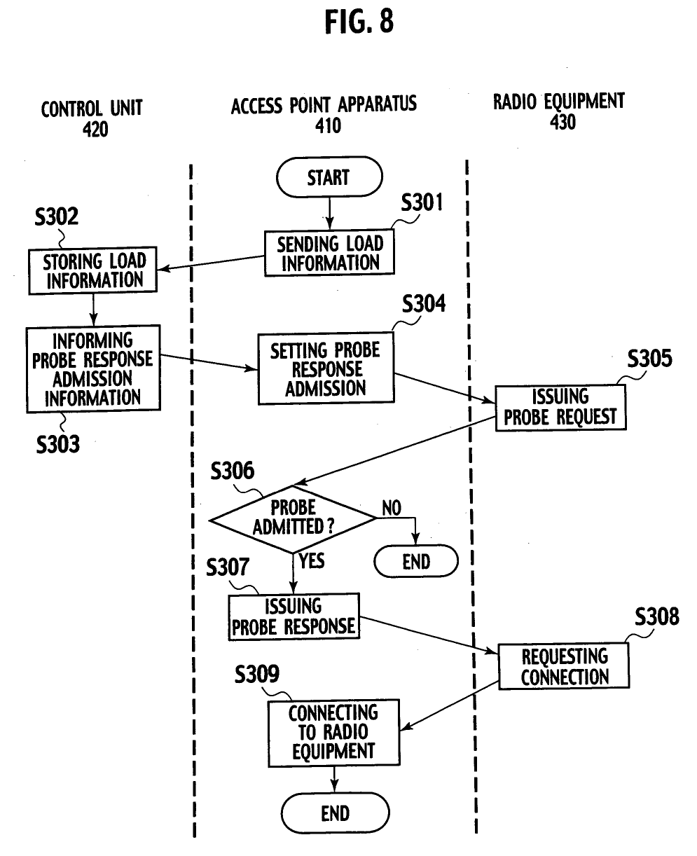

The radio communication system 400 of the third embodiment will be described in detail with reference to FIG. 8 in which operations of the access point apparatus 410, control unit 420 and radio equipment 430 are shown in parallel.

The load information memory 113 of the access point apparatus 410 stores connection information representing the radio equipments 430 currently in connection. The cable communication unit 112 reads the connection information from the load information memory 113, and periodically sends the connection information as load information of the access point apparatus 410 to the control unit 420 (stored in the setting memory 114) via the internal network 140 (step S301). Alternatively, the access point apparatus 410 may periodically send the load information, and may send the load information whenever a load state varies.

When receiving the load information via the internal network 140, the cable communication unit 121 of the control unit 420 transfers the received load information to the load controller 122, which stores the load information in an internal memory (step S302).

When the load information is stored, the load controller 122 creates new connection control information for respective access point apparatuses 410 in accordance with load states of a plurality of access point apparatuses, and sends the connection control information to the response admission information setting unit 423. The response admission information setting unit 423 determines admission or non-admission of the connection (i.e., probe response control information) for the respective access point apparatuses 410 in accordance with the connection control information, thereby producing probe response admission information. The cable communication unit 121 periodically sends the probe response admission information to the access point apparatuses 410 via the internal network 140 (step S303).

When an access point apparatus 410 has a heavy load, the probe response control information represents non-admission of connection. On the other hand, when an access point apparatus 410 has a light load, and the probe response control information represents admission of the connection. The admission and non-admission in the probe response control information are determined according to the following rule.

[Rule 1]

If (λ max−λ min<0.5×λ ave), the probe response control information is set to “admission”.
If (λ_i>λ ave), the probe response control information is set to “non-admission”.

Otherwise, the probe response control information is set to “admission”.

END

In the foregoing rule, “λ_i” denotes load received from an access point apparatus APi, “λ ave” denotes average load of each access point apparatus, “λ max” denotes a current maximum load of access point apparatuses, and “λ min” denotes a current minimum load of the access point apparatuses.

In the access point apparatus 410, the cable communication unit 112 receives the probe response admission information destined to itself via the internal network 140. The received information is stored in a response admission information memory 416 (step S304).

When the probe request unit 433 sends a probe request signal via the radio communication units 131 (step S305), the radio communication unit 111 checks whether the probe response admission information represents “admission” or “non-admission”. the admission information represents “non-admission” (No in step S306), the radio communication unit 111 does not send a probe response signal to the radio equipment 430. On the other hand, when the admission information represents “admission”(Yes in step S306), the radio communication unit 111 sends a probe response signal, which is produced by the response generator 415 on the basis of parameters stored in the setting memory 114, to the radio equipment 430 (step S307).

In the radio equipment 430, the radio communication unit 131 receives the probe response signal, and transfers it to the radio equipment 430, which pinpoints an access point apparatus 410 that has responded to the probe request signal first. Then, the access point selector 134 selects the pinpointed access point apparatus 410 as an apparatus to be connected. Thereafter, the radio communication unit 131 sends a connection request signal to the selected access point apparatus 410 (step S308).

The radio communication unit 111 of the access point apparatus 410 receiving the connection request signal connects to the radio equipment 430 requesting the connection, and stores the identification information of the radio equipment 430 in the load information memory 113 (step S309).

With the radio communication system in this embodiment, the probe response signal is sent only when the access point apparatus is admitted the connection by the control unit in accordance with the load state. This enables the connection to be established with the access point apparatus having a light load, which is effective in averaging loads between access points apparatuses.

Further, the loads of access point apparatuses can be informed to the radio equipment without worsening the bit error rate because no transmission power of the access points apparatuses is changed.

Still further, the radio equipment 430 simply sends the probe response signal only to the access point apparatus 410 which has responded to the connection request first, without using any additional unit for this purpose.

In the third embodiment, the probe response signal generator 415 of the access point apparatus 410 produces the probe response signal. Alternatively, the signal may be generated by an external unit of the access point apparatus 410, e.g. the control unit 420, and be sent to the access point apparatus 410 via the internal network 140. The access point apparatus 410 may send the probe response signal, received via the cable communication unit 112, via the radio communication unit 111. In such a case, when receiving the probe request signal from the radio equipment 430 via the radio communication unit 111, the access point apparatus 410 transfers the probe request signal to the control unit 420 via the internal network 140. The control unit 420 checks, in accordance with the foregoing Rule 1, whether or not the probe response signal should be sent to the access point apparatus 410. If the signal should be sent, the probe response signal is generated and sent to the access point apparatus 410 via the internal network 140, the access point apparatus 410 transferring the received probe response signal via the radio communication unit 111.

In this embodiment, the control unit 420 controls the load information of the access point apparatuses 410, and determines the transmission or non-transmission of the probe response signal via the access point apparatuses 410. Alternatively, the access point apparatuses 410 may be divided into groups, and the transmission or non-transmission of the probe response signal may be determined for respective groups.

As with the modified example of the first embodiment shown in FIG. 4, the control unit 420 controls the load information of a plurality of access point apparatuses 410 in the first group, creates probe response admission information for the respective access point apparatuses 310, and sends the information to the access point apparatuses 410 in the first group. Further, the control unit 420 controls the load information of a plurality of access point apparatuses 410 in the second group, creates the probe response admission information for the respective access point apparatuses 410, and sends the information to the access point apparatuses 410 in the second group. In short, the control unit 420 separately controls the access point apparatuses 410 in the first and second groups. In this case, the first and second groups may be identified and managed on the basis of addresses, e.g., IP addresses, of the access point apparatuses 410 in the internal network 140. Alternatively, the group identifiers may be stored in the setting memory 114, so that the first and second groups may be identified on the basis of the identifiers. The probe response control information may be determined with respect to the admission or non-admission for the respective groups in accordance with the foregoing rule.

[Rule 2]

If (λ g_max−λ g_min<0.5×λ g_ave), the probe response control information is set to “admission”.
If (λ gi>λ g_ave), the probe response control information is set to “non-admission”.

Otherwise, the probe response control information is set to “admission”

END

In the foregoing rule, “λ gi” denotes a load received from an access point apparatus APgi in a group g; λ g_ave denotes an average load of access point apparatuses in the group g,,; “λ g_max” denotes a maximum load of the access point apparatuses in the group g,; and “λg_min” denotes a minimum load of the access point apparatuses in the group g.

As described above, it is possible to average the loads of the access point apparatuses in the respective groups.

In the third embodiment, the probe response signal generator 415 of the access point apparatus 410 produces the probe response signal. Alternatively, the signal may be generated by an external unit of the access point apparatus 410, e.g. the control unit 420, and be sent to the access point apparatus 410 via the internal network 140. The access point apparatus 410 may send the probe response signal, received via the cable communication unit 112, via the radio communication unit 111. In such a case, when receiving the probe request signal from the radio equipment 430 via the radio communication unit 111, the access point apparatus 410 transfers the probe request signal to the control unit 420 via the internal network 140. The control unit 420 checks, in accordance with the foregoing Rule 2, whether or not the probe response signal should be sent to the access point apparatus 410. If the signal should be sent, the probe response signal is generated and sent to the access point apparatus 410 via the internal network 140, which transfers the received probe response signal via the radio communication unit 111.

### Fourth Embodiment

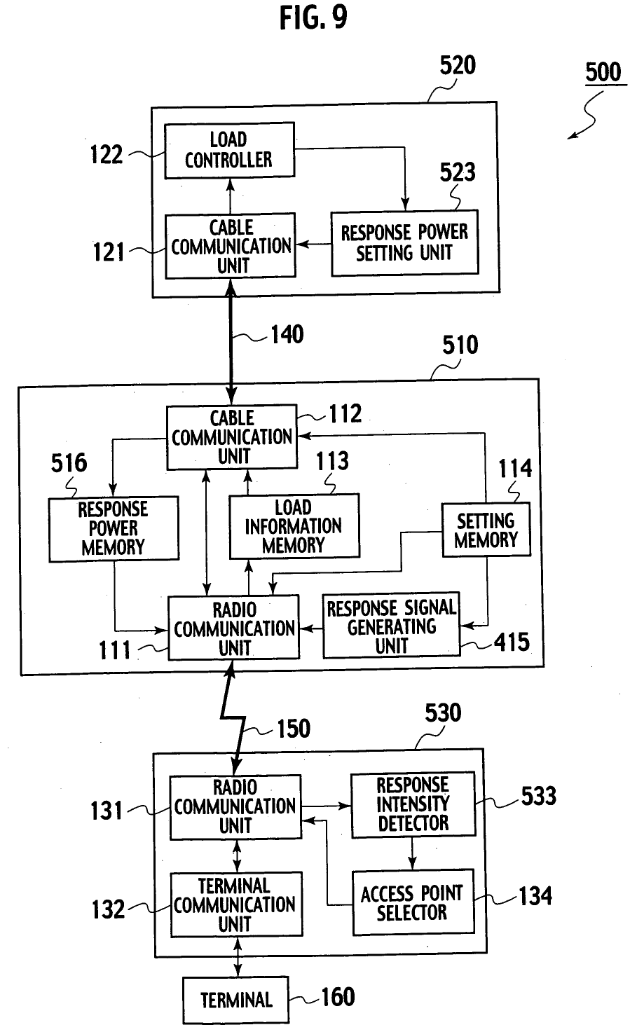

According to this embodiment, a radio communication system 500 shown in FIG. 9 controls transmission power of the probe response signal instead of controlling the transmission of the probe response signal conducted by the radio communication system 400 of the third embodiment.

The radio communication system 500 comprises access point apparatuses 510, a control unit 520 connected to the access point apparatuses 510 via an internal network 140, and radio equipment 530 connected to the terminal device 160 and access point apparatuses 510 via a radio channel 150.

The access point apparatus 510 includes a response power memory 516 in place of the response admission information memory 416 of the access point apparatus 410 in the third embodiment. The response power memory 516 receives response power information from the control unit 520, and stores the received information. The response power information represents power for transmitting a probe response signal. If no new response power information arrives from the control unit 520, the response power memory 516 deletes the existing response power information.

Referring to FIG. 9, the control unit 520 includes a response power setting unit 523 in place of the response admission information setting unit 423 of the control unit 420 in the third embodiment. The response power setting unit 523 determines power for the probe response signal, which is sent by the access point apparatus 510, in response to a demand from the load controller 122, and sends the response power information to the cable communication unit 121 as demanded by the load controller 122.

The radio equipment 530 includes a response intensity detector 533 in place of the probe request unit 433 used in the control unit of the third embodiment. In response to a connection request from a user via the terminal device 160, the response intensity detector 533 issues a probe request signal, and searches an access point apparatus 510 which responds to the probe request signal. Specifically, prior to establishing a connection between the radio equipment 530 and an access point apparatus 510, the response intensity detector 533 issues the probe request signal, and demands the radio communication unit 131 to send the probe request signal. Further, the response intensity detector 533 pinpoints an access point apparatus 510 to be connected when a probe response signal is received.

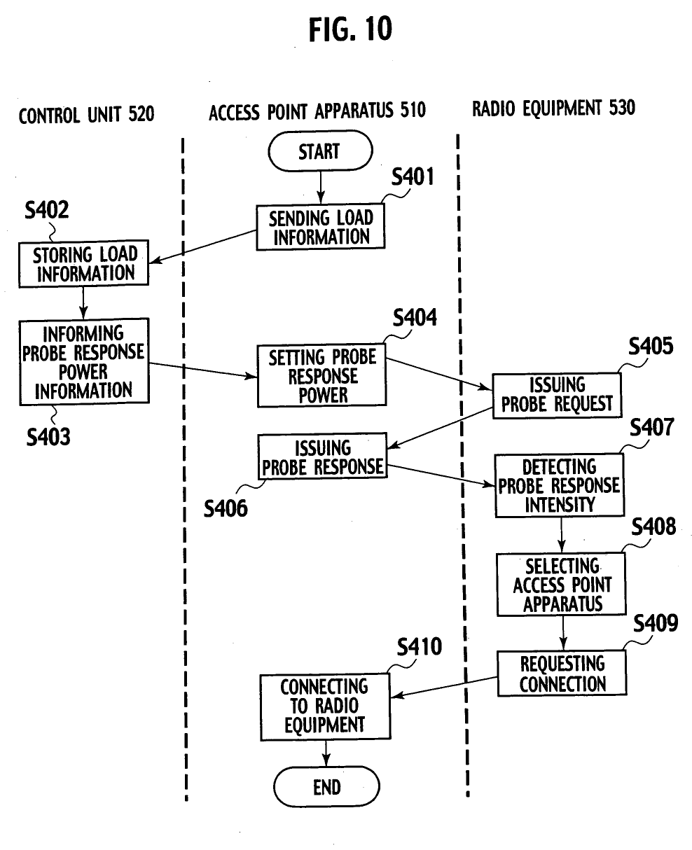

The operation of the radio communication system 500 will be described with reference to FIG. 10 in which the operations of the access point apparatus 510, control unit 520 and radio equipment 530 are shown in parallel.

The load information memory 113 of the access point apparatus 510 has stored connection information of the radio equipments 530 currently in connection. The cable communication unit 112 reads the connection information from the load information memory 113, and periodically sends the read information to the control unit 520 via the internal network 140 (step S401). The control unit 520 is stored in the setting memory 114. The access point apparatus 510 may periodically send the load information, or may send the information to the control unit 520 whenever a load state changes.

Upon receiving the load information via the internal network 140, the cable communication unit 121 of the control unit 520 transfers the load information to the load controller 122, which stores the load information in the internal memory (step S402).

Thereafter, the load controller 122 creates new connection control information for respective access point apparatuses 510 on the basis of the load information, and transfers the new connection control information to the power setting unit 523. The response power setting unit 523 determines transmission power of probe response signals for the respective access point apparatuses 510, and creates response power information. The cable communication unit 121 periodically sends the response power information to the respective access point apparatuses 510 via the internal network 140 (step S403).

The control unit 520 creates the response power information including transmission power to be sent by the respective access point apparatuses 510. The transmission power in the probe response signals is determined on the basis of the load information of the respective access point apparatuses 510. Specifically, lower transmission power is determined for access point apparatus 510 having a heavy load, while higher transmission power is determined for an access point apparatus 510 having a light load. The transmission power is derived using the following formula, for example.
Transmission power(AP_{—}i)=Pmin+(Pmax−Pmin)×(Max. load−Load(AP_{—}i))/(Max. load−min. load) [Formula 5]
where “transmission power (APᵢ)” denotes transmission power included in the response power information to be sent to an access point apparatus AP_i; “Max. load” denotes a maximum load in the load information for the access point apparatuses; “Min. load” denotes a minimum load in the load information for the access point apparatuses; “Load (AP_i) denotes a load in the access point apparatus 510; “Pmax” denotes predetermined maximum transmission power; and “Pmin” denotes predetermined minimum transmission power.

The cable communication unit 112 receives the response power information destined to itself, via the internal network 140, and stores it in the response power memory 516 (step S404).

When the response intensity detector 533 of the radio equipment 530 sends a probe request signal via the radio communication unit 131 (step S405), the radio communication unit 111 transfers a probe response signal, which has been generated by the response signal generator 415 on the basis of parameters stored in the setting memory 114, to the radio equipment 530 which has issued the probe request. In this state, the radio communication unit 111 refers to the response power information in the response power memory 516, and sends the probe response signal with transmission power specified in the response power information (step S406). The response power information is referred to only when the probe response signal is transmitted while the transmission power information in the setting memory 114 is referred to when sending a data packet. In short, the radio communication unit 111 increases or decreases the transmission power only when sending the probe response signal. If the response power memory 516 does not have the response power information, the radio communication unit 111 refers to the transmission power stored in the setting memory 114, and sends a beacon frame.

The radio communication unit 131 of the radio equipment 530 receives the probe response signal via the radio channel 150. Hence, the response intensity detector 533 obtains radio signal intensity data of probe response signals from the radio communication unit 131 (step S407).

The access point selector 134 compares the radio signal intensity data of the probe response signals detected by the response intensity detector 533, and selects an access point apparatus 510 which has sent the probe response signal having the maximum radio signal intensity (step S408). The probe response signal is sent with high power for an access point apparatus 510 having a light load while the probe response signal is sent with low power for an access point apparatus 510 having a heavy load. In short, the access point apparatus 510 which has sent the probe access signal at the maximum power is considered to have a light load or to be positioned nearest the radio equipment 530. Alternatively, the radio equipment 530 may repeatedly execute steps S405 to S407 at a plurality of radio frequencies, so that the access point apparatus 510 which has received the probe response signal with the maximum radio signal intensity will be selected.

The radio equipment 131 sends a connection request to the selected access point apparatus 510 (step S409).

Receiving the connection request, the access point apparatus 510 connects to the radio equipment 530 which has issued the connection request, and stores an identification code of the radio equipment 530 in the load information memory 113 (step S410).

With the radio communication system 500, each access point apparatus 510 sends the probe response signal with transmission power depending upon its load. The radio equipment 530 issues the connection request to the access point apparatus 510 whose reception intensity is maximum, and connects to the access point apparatus whose load is light. These features are effective in averaging loads between the access point apparatuses.

Each access point apparatus controls its transmission power of the probe response signal, and data packets are sent at the ordinary transmission power. Therefore, the load of the access point apparatus can be informed to the radio equipment without worsening the bit error rate.

In this embodiment, the probe response signal generator 415 of the access point apparatus 510 produces the probe response signal. Alternatively, the signal may be generated by an external unit of the access point apparatus 510, e.g. the control unit 520, and be sent to the access point apparatus 510 via the internal network 140. The access point apparatus 510 may send the probe response signal, received via the cable communication unit 112, via the radio communication unit 111. In such a case, when receiving the probe request signal from the radio equipment 530 via the radio communication unit 111, the access point apparatus 510 transfers the probe request signal to the control unit 520 via the internal network 140. Then, the control unit 520 generates a probe response signal, and sends it to the access point apparatus 510 via the internal network 140. The access point apparatus 510 transfers the probe response signal, received via the cable communication unit 112, via the radio communication unit 111.

With the radio communication system 500 shown in FIG. 9, the control unit 520 controls the load information of the access point apparatuses 510 belonging thereto, and determines transmission power of the probe response signals for the access point apparatuses 510. Alternatively, the access point apparatuses 510 may be divided into groups, and the transmission power of the probe response signals may be controlled for the respective groups.

As with the modified example of the first embodiment shown in FIG. 4, the control unit 520 controls the load information of a plurality of access point apparatuses 510 in the first group, creates probe response admission information for them, and sends the information to them. Further, the control unit 520 controls the load information of a plurality of access point apparatuses 510 in the second group, creates the probe response admission information for them, and sends the information to them. In short, the control unit 520 separately controls the access point apparatuses 510 in the first and second groups. In this case, the first and second groups may be identified and managed on the basis of addresses, e.g., IP addresses, of the access point apparatuses 510 in the internal network 140. Alternatively, the group identifiers may be stored in the setting memory 114, so that the first and second groups may be identified on the basis of the identifiers. The transmission power of the probe response signal may be calculated using the following formula.
Transmission power(AP_{—}gi)=Pmin+(Pmax−Pmin)×(Max. load g−Load(AP_{—}gi))/(Max. load g−Min. loadg) [Formula 6]
where “transmission power (AP_gi)” denotes transmission power included in the response power information to be sent to an access point apparatus AP_gi in a group g; “Max. load g” denotes maximum load among the access point apparatuses in the group g; “Min. load g” denotes minimum load among the access point apparatuses in the group g; “Load (AP_gi) denotes a load of the access point apparatus 510 in the group g; “Pmax” denotes predetermined maximum transmission power; and “Pmin” denotes predetermined minimum transmission power.

The loads of the access point apparatuses 520 in each group can be averaged by calculating the transmission power of the probe response signal as described above.

In this embodiment, the probe response signal generator 415 of the access point apparatus 510 produces the probe response signal. Alternatively, the signal may be generated by an external unit of the access point apparatus 510, e.g. the control unit 520, and be sent to the access point apparatus 510 via the internal network 140. The access point apparatus 410 may send the probe response signal, received via the cable communication unit 112, via the radio communication unit 111. In such a case, when receiving the probe request signal from the radio equipment 530 via the radio communication unit 111, the access point apparatus 510 transfers the probe request signal to the control unit 520 via the internal network 140. The access point apparatus 510 sends the received probe response signal via the radio communication unit 111.

### Fifth Embodiment

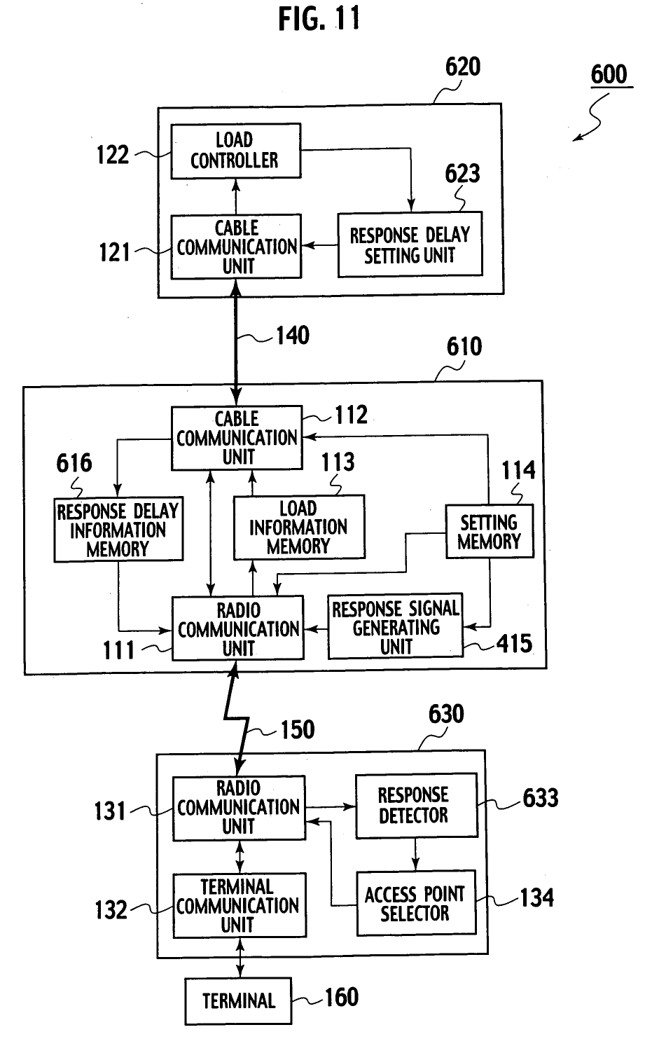

A radio communication system 600 according to a fifth embodiment will be described with reference to FIG. 11. With the radio communication system 600, transmission timings of the probe response signal are controlled in place of controlling the transmission power of the probe response signal in the third embodiment.

The radio communication system 600 comprises access point apparatuses 610, a control unit 620 connected to the access point apparatuses 610 via an internal network 140, and radio equipment 630 connected to the terminal 160 and access point apparatuses 610 via a radio channel 150.

The access point apparatus 610 includes a response delay information memory 616 in place of the response admission information memory 416 of the access point apparatus 410 in the third embodiment. The response delay information memory 616 receives response delay information from the control unit 620, and stores the received information. The response delay information represents a transmission delay of a probe response signal. If no new response delay information arrives from the control unit 620, the response delay information memory 616 deletes the existing response delay information.

Referring to FIG. 11, the control unit 620 includes a response delay setting unit 623 in place of the response admission information setting unit 423 of the control unit 420 in the third embodiment. The response delay setting unit 623 determines a delay time for sending the probe response signal, which is sent by the access point apparatus 610, in response to a demand from the load controller 122, and sends the response delay information to the cable communication unit 121 as demanded by the load controller 122.

The radio equipment 630 includes a response detector 633 in place of the probe request unit 433 used in the control unit of the third embodiment. In response to a connection request from a user via the terminal device 160, the response detector 633 issues a probe request signal, and searches access point apparatuses 610 which responds to the probe request signal. Specifically, prior to establishing a connection between the radio equipment 630 and an access point apparatus 610, the response detector 633 issues the probe request signal, and demands the radio communication unit 131 to send the probe request signal. Further, the response delay detector 633 pinpoints an access point apparatus 610 to be connected when a probe response signal is received.

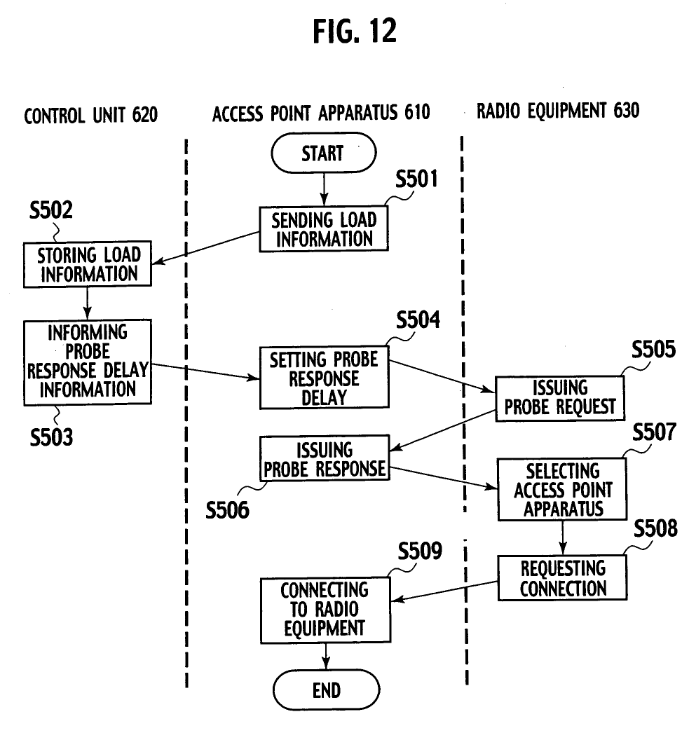

The operation of the radio communication system 600 will be described with reference to FIG. 12, in which the operations of the access point apparatus 610, control unit 620 and radio equipment 630 are shown in parallel.

The load information memory 113 has stored connection information of the radio equipments 630 current in connection. The cable communication unit 112 reads the connection information from the load information memory 113, and periodically sends the read information to the control unit 620 via the internal network 140 (step S501). The access point apparatus 610 may periodically send the load information, or may send the information to the control unit 620 whenever a load state changes.

Upon receiving the load information via the internal network 140, the cable communication unit 121 of the control unit 620 transfers the load information to the load controller 122, which stores the load information in the internal memory (step S502).

The load controller 122 creates new connection control information for respective access point apparatuses 610 on the basis of the load information, and transfers the new connection control information to a response delay setting unit 623. The response delay setting unit 623 determines a response delay time for probe response signals to be sent by the respective access point apparatuses 610, and creates response delay information. The cable communication unit 121 periodically sends the response delay information to the respective access point apparatuses 610 via the internal network 140 (step S503).

The control unit 620 creates the response delay information including response delay time of the probe response signal to be sent by the respective access point apparatuses 610. The response delay information in the probe response signals is determined on the load information of the respective access point apparatuses 610. Specifically, a longer response delay time is determined for an access point apparatus 610 having a heavy load, while a shorter response delay time is determined for an access point apparatus 610 having a light load. The response delay time is derived using the following formula, for example.
Response delay time(AP_{—}i)=Dmin+(Dmax−Dmin)×(Load(AP_{—}i)−Min. load)/(Max. load−Min. load) [Formula 7]
where “response delay time(AP_i)”denotes response delay time included in the response delay information to be sent to an access point apparatus AP_i; “Max. load” denotes maximum load among the access point apparatuses; “Min. load” denotes minimum load among the access point apparatuses; “Load (AP_i) denotes a load of the access point apparatus (AP_I); “Dmax” denotes predetermined maximum transmission delay; and “Dmin” denotes predetermined minimum transmission delay.

The cable communication unit 112 receives the response delay information destined to itself, via the internal network 140, and stores it in the response delay information memory 616 (step S504).

When a response detector 633 of the radio equipment 630 sends a probe request signal via the radio communication unit 131 (step S505), the radio communication unit 111 transfers a probe response signal, which is generated by the response signal generator 415 on the basis of parameters stored in the setting memory 114, to the radio equipment 630 which has issued the probe request. In this state, the radio communication unit 111 refers to a back-off time specified by the radio communication standard, e.g., a back-off time which is derived using random numbers in accordance with the IEEE 802.11 specification, and the response delay information stored in the response delay information memory 616, and calculates a response delay by adding the foregoing back-off time and transmission delay time stored in the response delay information memory 616, and sends a probe response signal after lapse of the calculated response delay time (step S506).

The radio communication unit 131 of the radio equipment 630 receives the probe response signal via the radio channel 150. Hence, the response detector 633 pinpoints the access point apparatus 610 which has sent the probe response signal first to the radio communication unit 131. Hence, the access point selector 134 selects the pinpointed access point apparatus 610 as an access point apparatus to be connected (step S507).

The radio communication unit 131 sends a connection request to the selected access point apparatus 610 (step S508).

Receiving the connection request, the access point apparatus 610 connects to the radio equipment 630 which has issued the connection request, and stores an identification code of the radio equipment 630 in the load information memory 113 (step S509).

With the radio communication system 600, each access point apparatus 510 sends the probe response signal with a delay time depending upon its load. The radio equipment 630 tends to receive the probe response signal from the access point apparatus 610 having a light load, and issues a connection request to such an access point apparatus 610. This is effective in averaging loads between the access point apparatuses.

With the radio communication system of this embodiment, the loads of the access point apparatuses can be informed to the radio equipment without varying the transmission power of the access point apparatuses and without worsening the bit error rate.

In the foregoing description, the delay for sending the probe response signal is calculated by adding the back-off time and the transmission delay time. Alternatively, the back-off time and the transmission delay time in the response delay information may be multiplied to derive the delay time for sending the probe response signal.

With the radio communication system 600, the radio equipment issues the connection request to the access point apparatus which has received the probe response signal first. Alternatively, the response detector 633 may compare delay times for sending the probe response signals of respective access point apparatuses 610, and the access point apparatus 610 whose transmission delay is shortest may be selected. The radio equipment 630 can reliably connect to the access point apparatus 630 having a light load. Further, the radio equipment 630 may repeat steps S505 to S507 at different radio frequencies, and select the access point apparatus 610 which has received the probe response signal with a shortest delay.

In this embodiment, the probe response signal generator 415 of the access point apparatus 610 produces the probe response signal. Alternatively, the signal may be generated by an external unit of the access point apparatus 610, e.g. the control unit 620, and be sent to the access point apparatus 610 via the internal network 140. The access point apparatus 610 may send the probe response signal, received via the cable communication unit 112, via the radio communication unit 111. In such a case, when receiving the probe request signal from the radio equipment 630 via the radio communication unit 111, the access point apparatus 610 transfers the probe request signal to the control unit 620 via the internal network 140. The access point apparatus 610 sends the received probe response signal via the radio communication unit 111. The access point apparatus 610 delays the probe response signal by the time, which is stored in the response delay information memory 616, via the radio communication unit 111. Alternatively, the control unit 620 delays the probe response signal by the time calculated using the Formula 7. Immediately after receiving the probe response signal from the control unit 620, the access point apparatus 620 transfers it via the radio communication unit 111.

With the radio communication system 600, the control unit 620 controls the load information of the access point apparatuses 610 belonging thereto, and determines the response delay information on the basis of the load information. Alternatively, the access point apparatuses may be divided into a plurality of groups, and the response delay information may be determined for the respective groups.

As with the modified example of the first embodiment (shown in FIG. 4), the control unit 620 controls the load information of a plurality of access point apparatuses 610 in the first group, creates beacon timing information for the respective access point apparatuses 610, and sends the information to the access point apparatuses 610 in the first group. Further, the control unit 620 controls the load information of a plurality of access point apparatuses 610 in the second group, creates beacon timing information for them, and sends the information to them. In short the control unit 320 separately controls the access point apparatuses 610 in the first and second groups. In this case, the first and second groups may be identified and managed on the basis of addresses of the access point apparatuses 610 in the internal network 140, e.g., IP addresses. Alternatively, group identifiers may be stored in the setting memory 114 in order to identify the first and second groups. The delay time for sending the response delay information will be calculated using the following formula, for example.
Response delay time(AP_{—}gi)=Dmin+(Dmax−Dmin)×(Load(AP_{—}gi)−Min. load g)/(Max. load g−Min. load g) [Formula 8]
where “response delay time(AP_gi)” denotes response delay time included in the response delay information to be sent to an access point apparatus AP_gi in a group g; “Max. load g” denotes a maximum value of load information of the access point apparatuses in the group g; “Min. load g” denotes a minimum value of load information of the access point apparatuses in the group g; “Load (AP_gi) denotes a load of the access point apparatus (AP_gi) in the group g; “Dmax” denotes predetermined maximum transmission delay time; and “Dmin” denotes predetermined minimum transmission delay time.

The calculated transmission delay time is effective in averaging the loads of the access point apparatuses in the respective groups.

In this embodiment, the probe response signal generator 415 of the access point apparatus 610 produces the probe response signal. Alternatively, the signal may be generated by an external unit of the access point apparatus 610, e.g. the control unit 620, and be sent to the access point apparatus 610 via the internal network 140. The access point apparatus 610 may send the probe response signal, received via the cable communication unit 112, via the radio communication unit 111. In such a case, when receiving the probe request signal from the radio equipment 630 via the radio communication unit 111, the access point apparatus 610 transfers the probe request signal to the control unit 620 via the internal network 140. The control unit 620 creates a probe response signal, and sends it to the access point apparatus 610. The access point apparatus 610 sends the received probe response signal via the radio communication unit 111. The access point apparatus 610 delays the probe response signal by the time, which is stored in the response delay information memory 616, via the radio communication unit 111. Alternatively, the control unit 620 delays the probe response signal by the time calculated using the formula 8. Immediately after receiving the probe response signal from the control unit, the access point apparatus 620 transfers it via the radio communication unit 111.

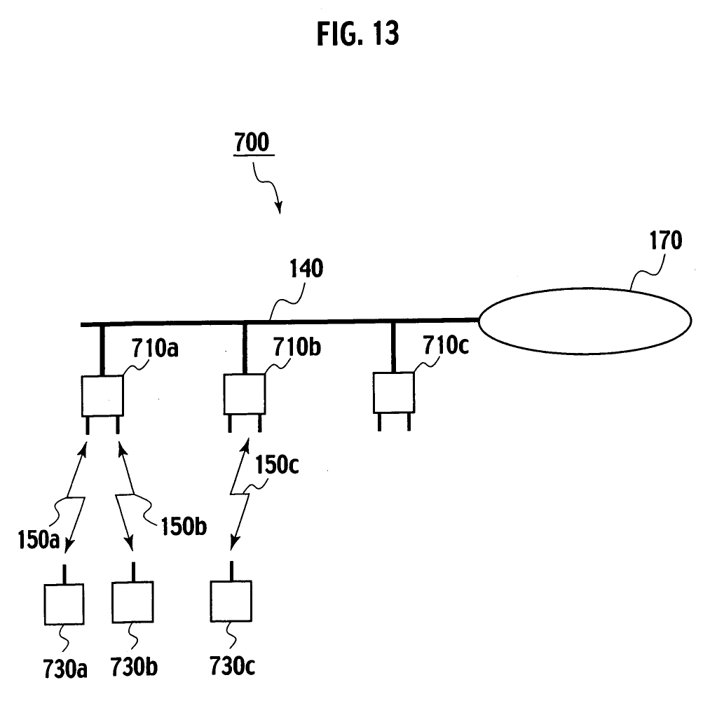

A modified example of the radio communication systems of the first to fifth embodiments will be described with reference to FIG. 13.

With the radio communication systems of the first to fifth embodiments, the access point apparatuses notify their load information to the control unit, which controls the access point apparatus on the load information. In the modified example, a radio communication system 700 controls new radio equipment connections to access point apparatuses without using a control unit.

Referring to FIG. 13, the radio communication system 700 comprises access point apparatuses 710 interconnected via an internal network 140, radio equipment 730 connected to the access point apparatuses 710 via a radio channel 150, and a terminal (not shown). The internal network 140 is connected to an external network 170.

With the radio communication system 700, each access point 710 periodically sends its own load information to a predetermined multicast address, and receives a packet destined to the multicast address, which enables the access point apparatus 710 to know load states of other access point apparatuses 710. The access point apparatus 710 adjusts and sets not only its own load information but also any one of items such as a beacon transmission power or beacon transmitting interval derived on the basis of the Formulas 1, 3, 5 and 7 and Rule 1, admission/non-admission of the probe response, probe signal transmitting power and probe response transmission delay time. A new radio equipment 730 connects to an access point apparatus 710 having a light load.

In the modified example, the radio communication equipment can be controlled without using a control unit, which is effective in averaging loads between access point apparatuses.

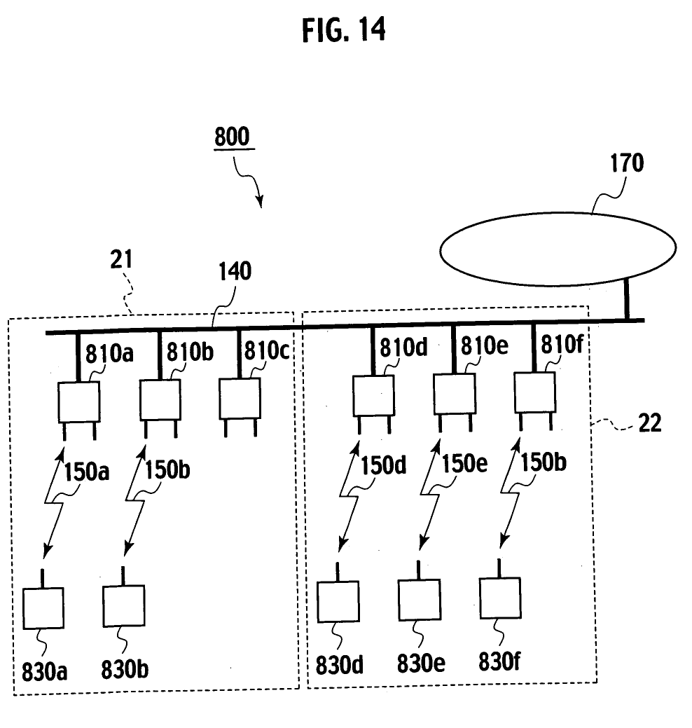

A further modified example of the foregoing radio communications systems will be described with reference to FIG. 14. In this example, the access point apparatuses are divided into a plurality of groups.

Referring to FIG. 14, the radio communication system 800 comprises access point apparatuses 810 interconnected via an internal network 140, radio equipment 830 connected to the access point apparatuses 810 via radio channel 150, and a terminal (not shown). The internal network 140 is connected to an external network 170.

With the radio communication system 800, the access point apparatuses 810 are divided into groups whose identifiers are 21 and 22. Each access point apparatus 810 periodically sends its own load information to a multicast address whose group identifier is predetermined, and receives a packet destined to the multicast address. In short, the access point apparatuses 810a to 810c receive the multicast address in the group 21 while the access point apparatuses 810d to 810f receive the multicast address in the group 22. Each access point apparatus 810 can know load states of the access point apparatuses 810 in the same group. The access point apparatus 810 adjusts and sets any one of items such as a beacon transmission power or beacon transmission timing derived on the basis of the Formulas 2, 4, 6 and 8 and Rule 2, admission/non-admission of the probe response, probe signal transmitting power and probe response sending delay. A new radio equipment 830 connects to an access point apparatus 810 having a light load.

In the modified example, the radio communication equipment can be controlled without using a control unit, which is effective in averaging loads between access point apparatuses in the respective groups.

In the foregoing radio communication systems, the control unit controls the load information of the access point apparatuses, and determines the transmission power and transmission intervals of beacons, and the transmission or non-transmission, transmission power and transmission delay of the probe response signals. Alternatively, the control unit may collect load information of the access point apparatuses, and inform the collected information to the access point apparatuses. In such a case, each access point apparatus may store load information of its adjacent access point apparatuses in place of the beacon power information and so on, and determine beacon transmission power and so on based on the load information. This holds true to radio communication systems in which access point apparatuses are divided into groups.

A variety of methods are available for grouping the access point apparatuses. For instance, access point apparatuses which received the probe request signal from the radio equipment are grouped. The transmission or non-transmission, transmission power and transmission delay of the probe response signal may be determined on the basis of the load state of the access point apparatuses in the group. This enables only an access point apparatus near the radio equipment to send the probe response signal, which is effective in controlling the load efficiently.

In the first to fifth embodiment, when the control unit or the access point apparatus knows the load information of other access point apparatuses, the parameters such as the transmission power and transmission timing of beacon frames, and transmission or non-transmission, transmission power and transmission delay of the probe response signal are adjusted on the basis of the load information. Alternatively, each access point apparatus may adjust its own parameters on the basis of its own load information without paying attention to the load information of other access point apparatuses.

The transmission power of the beacon frame is calculated using the following formula so that the access point apparatus adjusts its transmission power of the beacon frame on the basis of its load information.
Transmission power(AP_{—}i)=Pmin+(Pmax—Pmin)×(Max. load(AP_{—}i)−Load(AP_{—}i))/(Max. load(AP_{—}i)−Min. load (AP_{—}i)) [Formula 9]
where “transmission power (AP_i)” denotes transmission power at which an access point apparatus AP_i sends a beacon frame; “Load (AP_i)” denotes a current load of the access point apparatus AP_i; “Max. load (AP_i)” denotes a predetermined maximum load of the access point apparatus AP_i; “Min. load (AP_i)” denotes a predetermined minimum load of the access point apparatus AP_i; “Pmax” denotes predetermined transmission power; and “Pmin” denotes predetermined minimum transmission power.

Further, the access point apparatus can adjust the beacon frame transmission timing on the basis of its load information when the transmission timing is calculated using the following formula.
Transmission interval(AP_{—}i)=(Max. load(AP_{—}i)−Load((AP_{—}i))/(Max. load(AP_{—}i)−Min. Load(AP_{—}i))×(Tmax−Tmin)+Tmin [Formula 9]
where “transmission interval (AP_i)” denotes transmission interval at which an access point apparatus AP_i sends beacon frames; “Max. load (AP_i)” denotes a predetermined maximum load of the access point apparatus AP_i; “Min. load (AP_i)” denotes a predetermined minimum load of the access point apparatus AP_i; “Load (AP_i)” denotes a load of the access point apparatus AP_i; “Tmax” denotes predetermined maximum transmission interval and “Tmin” denotes predetermined minimum transmission interval.

When the access point apparatus sends beacon frame at the transmission power or transmission interval, a new radio equipment tries to connect to the access point apparatus sending the beacon frame. Therefore, it is possible to connect to the access point apparatus having the lightest load, which is effective in averaging the load between access point apparatuses.

The transmission/non-transmission of the probe response signal is determined on the basis of the following Rule. This enables the access point apparatus to determine the transmission/non-transmission of the probe response signal according to its load information.

[Rule 3]

If (λ_i<λ i_max), transmission of the probe signal is admitted.

Otherwise, transmission of the probe signal is not admitted.

END

In the Rule 3, “λ_i” denotes load of an access point apparatus APi; “λ i_max” denotes predetermined maximum allowable load of the access point apparatus APi.

When the access point apparatus decides transmission of the probe response signal, a new radio equipment sends a probe request signal, and tries to connect to the access point apparatus which has sent the probe response signal. In short, the radio equipment can connect to the access point apparatus having the lightest load, so that load can be averaged between access point apparatuses.

Further, when the transmission power of the probe response signal is calculated using the following formula, the access point apparatus can adjust its transmission power of the probe response signal only on the basis of its load information.
Transmission power(AP_{—}i)=(Max. load(AP_{—}i)−Load(AP_{—}i))/(Max. load(AP_{—}i)−Min. load(AP_{—}i))×(Pmax−Pmin)+Pmin [Formula 11]
where “Transmission power (AP_i)” denotes transmission power of an access point apparatus AP_i; “Max. load (AP_i)” denotes predetermined maximum allowable load of the access point apparatus AP_i; “Min. load (AP_i)” denotes predetermined minimum load of the access point apparatus AP_i; “Load (AP_i)” denotes load of the access point apparatus AP_i; “Pmax” denotes predetermined maximum transmission power; and “Pmin” denotes predetermined minimum transmission power.

Once the access point apparatus determines the transmission power of the probe response signal, a new radio equipment tries to connect to the access point apparatus which has sent the probe response signal with strongest transmission power. This enables the radio equipment to get access to the access point apparatus having the lightest load, which is effective in averaging the load between access point apparatuses.

Further, the access point apparatus calculates the transmission delay of the probe response signal using the following formula, and adjusts the transmission delay only on the basis of its load information.
Transmission delay(AP_{—}i)=(Max. load(AP_{—}i)−Load(AP_{—}i))/(Max. load(AP_{—}i)−Min. load(AP_{—}i))×(Dmax−Dmin)+Dmin [Formula 12]
where “Transmission delay (AP_i)” denotes transmission delay of an access point apparatus AP_i; “Max. load (AP_i)” denotes predetermined maximum allowable load of the access point apparatus (AP_i); “Min. load (AP_i)” denotes predetermined minimum load of the access point apparatus (AP_i); “Load (AP_i)” denotes load of the access point apparatus AP_i; “Dmax” denotes predetermined maximum transmission delay; and “Pmin” denotes predetermined minimum transmission delay.

When determining the transmission delay of the probe response signal on the basis of the foregoing formula and a back-off time, an access point apparatus having a light load can quickly send the probe response signal in response to the probe request signal from the radio equipment. New radio equipment tries to connect to the access point apparatus which has sent the probe response signal first, which enable the radio equipment to be connected to the access point apparatus having the lightest load. This is effective in averaging the load between access point apparatuses.

In the foregoing description of the embodiments, the standard of the IEEE 802.11a, 802.11b or 802.11g is adopted as the communication protocol for the connections between the access point apparatuses and the radio equipment. Alternatively, the invention is applicable to a radio communication system in which an access point apparatus sends control information concerning its availability, and the radio equipment locates the access point apparatus on the basis of the control information.

Further, in the foregoing description, the access point apparatuses are connected to the control unit via the internal network, i.e., a local area network. Alternatively, they may be connected by any other network via which the access point apparatuses and radio equipment can transmit and receive control information such as load information, beacon power information therebetween.

The control unit is positioned between the internal network and external network. Alternatively, any type of configuration is applicable so long as the control information such as load information and beacon power information can be transmitted and received between the access point apparatuses and the control unit.

In the foregoing description, the access point apparatus controls its new connection on the basis of the parameters such as the transmission power and transmission intervals of beacons, and transmission/non-transmission, transmission power and transmission delay of the probe response signal. Alternatively, some of the foregoing parameters may be used in combination.

The access point apparatuses, radio equipment and control unit may be realized using a computer and a computer program. In such a case, the computer executes various processes in accordance with a program stored in a memory. Alternatively, the invention may be realized using a plurality of computers connected to a network. The computer may be an arithmetic processing unit in an information processor, a microcomputer or the like which can be operated by a program.

According to the invention, the beacon frames and probe response signals are controlled depending upon the load state of access point apparatuses. Therefore, the radio equipment can connect to an access point apparatus having a light load, which is effective in averaging the load between access point apparatuses. Thus, radio communications with short delay and high throughput can be offered.

The present invention is also applicable to industries related to radio communications and device manufacturing industries.

What is claimed is:

1. An access point apparatus comprising:
a first communication unit sending a radio terminal a beacon representing the availability of an access point apparatus, and receiving a connection request signal from the radio terminal in response to the beacon;
a second communication unit communicating with a control unit which controls a load state of the access point apparatus via the first communication unit;
a memory storing connection control information received from the control unit via the second communication unit, the connection control information depending upon the load state of the access point apparatus; and
a connection control unit controlling the operation of the first communication unit on the basis of the connection control information.

2. The access point apparatus of claim 1, wherein the access point apparatus is one of a plurality of access point apparatuses constituting a radio communication system and connected to the radio terminal, and the second communication unit receives the load state of each access point apparatus.

3. The access point apparatus of claim 1, wherein the connection control information is used to prevent a connection of the first communication unit having a heavy load, but promoting the connection of the first communication unit having a light load.

4. The access point apparatus of claim 2, wherein the connection control information is used to prevent a connection of the first communication unit having a heavy load, but promoting the connection of the first communication unit having a light load.

5. The access point apparatus of claim 3, wherein the connection control unit controls transmission power of the beacon on the basis of the connection control information.

6. The access point apparatus of claim 1, wherein the connection control unit controls the number of times of transmitting the beacons on the basis of the connection control information.

7. An access point apparatus comprising:
a first communication unit receiving via a radio terminal a search request signal representing the availability of an access point apparatus, and sending a search response signal via the radio terminal in response to the search request signal;
a second communication unit connected to a control unit which controls a load state of an access point apparatus via the first communication unit;
a memory storing connection control information received from the control unit via the second communication unit, the connection control information depending upon the load state of the access point apparatus; and
a connection control unit controlling the operation of the first communication unit on the basis of the connection control information.

8. The access point apparatus of claim 7, wherein the access point apparatus is one of a plurality of access point apparatuses constituting a radio communication system and connected to the radio terminal, and the second communication unit receives the load state of each access point apparatuses.

9. The access point apparatus of claim 7, wherein the connection control information is used to prevent a connection of the first communication unit having a heavy load, but promoting the connection of the first communication unit having a light load.

10. The access point apparatus of claim 8, wherein the connection control information is used to prevent a connection of the first communication unit having a heavy load, but promoting the connection of the first communication unit having a light load.

11. The access point apparatus of claim 9, wherein the connection control unit determines whether or not to transmit the search response signal on the basis of the connection control information.

12. The access point apparatus of claim 7, wherein the connection control unit controls transmission power of the search response signal on the basis of the connection control information.

13. The access point apparatus of claim 7, the connection control unit controls a transmission delay of the search response signal on the basis of the connection control information.

14. A radio communication system comprising:
a plurality of radio terminals;
a plurality of access point apparatuses connected to the radio terminals; and
a control unit controlling load states of the access point apparatuses, wherein each access point apparatus comprises a first communication unit sending the radio terminal a beacon representing the availability of the access point device and receiving a connection request signal from the radio terminal in response to the beacon; a second communication unit connected to the control unit and receiving connection control information from the control unit, the connection control information depending upon the load state; and a connection control unit controlling the operation of the first communication unit on the basis of the connection control information.

15. The radio communication system of claim 14, wherein the second communication unit receives load state information of each access point apparatuses.

16. The radio communication system of claim 14, wherein the connection control information is used to prevent a connection of the first communication unit having a heavy load, but promoting the connection of the first communication unit having a light load.

17. The radio communication system of claim 15, wherein the connection control information is used to prevent a connection of the first communication unit having a heavy load, but promoting the connection of the first communication unit having a light load.

18. The radio communication system of claim 16, wherein the connection control unit controls beacon transmission power.

19. The radio communication system of claim 14, wherein the connection control unit controls the number of times of transmitting the beacon on the basis of the connection control information.

20. A radio communication system comprising:
a plurality of radio terminals;
a plurality of access point apparatus connected to the radio terminals; and
a control unit controlling load states of the access point apparatuses; wherein each access point apparatus comprises a first communication unit receiving a search request signal investigating the availability of access point apparatuses from the radio terminal and sending a search response signal in response to the search request signal; a second communication unit connected to the control unit and receiving connection control information from the control unit, the connection control information depending upon the load state; and a connection control unit controlling the operation of the first communication unit on the basis of the connection control information.

21. The radio communication system of claim 20, wherein the second communication unit receives load state information of o each access point apparatuses.

22. The radio communication system of claim 20, wherein the connection control information is used to prevent a connection of the first communication unit having a heavy load, but promoting the connection of the first communication unit having a light load.

23. The radio communication system of claim 21, wherein the connection control information is used to prevent a connection of the first communication unit having a heavy load, but promoting the connection of the first communication unit having a light load.

24. The radio communication system of claim 22, wherein the communication control unit determines whether or not to send the search request signal on the basis of the connection control information.

25. The radio communication system of claim 20, wherein the connection control unit controls power for sending the response signal on the basis of the connection control information.

26. The radio communication system of claim 20, wherein the connection control unit controls a transmission delay of the search response signal on the basis of the connection control information.

27. A method of connecting radio terminal in a radio communication system constituted by a plurality of access point apparatuses and a control unit controlling load states of access point apparatuses, the method comprising:
downloading connection control information from the control unit, the connection control information depending upon a load state of an access point apparatus; and
controlling transmission of a beacon representing the availability of the access point apparatus to the radio terminal on the basis of the connection control information.

28. The method of claim 27 further comprising:
receiving a load state of each access point apparatuses;, and
controlling transmission of a beacon representing the availability of the access point apparatus to the radio terminal on the basis of the connection control information.

29. A method of connecting radio terminals in a radio communication system constituted by a plurality of access point apparatuses, and a control unit controlling load states of access point apparatuses, the method comprising:
receiving connection control information of the access point apparatus from the control unit in response to a search request signal, the search request signal investigating the availability of the access point apparatuses and received from the radio terminal; and
controlling transmission of a search response signal in response to the search request signal on the basis of connection control information depending upon the received load state.

30. The method of claim 29 further comprising receiving load information of each access point apparatuses, and controlling transmission of a search response signal on the basis of the connection control information depending upon the load state.
